(19) United States
(12) Patent Application Publication
(10) Pub. No.: US 2025/0205958 A1
(43) Pub. Date: Jun. 26, 2025

(54) PLANT AND METHOD FOR PRODUCING CONTAINERS

(71) Applicant: Krones AG, Neutraubling (DE)

(72) Inventor: Michael BEYER, Wenzenbach (DE)

(21) Appl. No.: 18/981,126

(22) Filed: Dec. 13, 2024

(30) Foreign Application Priority Data
Dec. 21, 2023 (DE) 10 2023 136 335.2

(51) Int. Cl. B29C 49/06; B29C 49/28; B29L 31/00

(52) U.S. Cl. CPC B29C 49/062; B29C 49/28008; B29L 2031/712

(57) ABSTRACT

The disclosure relates to a plant for producing containers, the plant comprising a production machine for producing preforms, a blow molding machine for producing containers from the preforms and a transport device for transporting the preforms from the production machine to the blow molding machine, wherein the plant comprises a retooling apparatus for retooling at least one component of the production machine and/or the blow molding machine.

### CROSS REFERENCE TO RELATED APPLICATION

The present application claims priority to German Patent Application No. 10 2023 136 335.2 filed on Dec. 21, 2023. The entire contents of the above-listed application are hereby incorporated by reference for all purposes.

### TECHNICAL FIELD

The present disclosure relates to a plant for producing containers and to a method for retooling a plant for producing containers.

### BACKGROUND

Plants for producing containers are well known in the prior art. In particular, non-blocked and blocked designs are known. In the non-blocked designs, preforms for the containers are produced using injection molding machines, for example, and then temporarily stored. Here, further transport of the produced preforms to a processing company that produces containers from the preforms can also be provided. After intermediate storage, the preforms are then formed into containers, for example using blow molding machines, and then further processed, in particular filled, sealed and decorated, for example by applying labels or printed images.

### SUMMARY

In blocked plants, the production of the preforms takes place together with the further treatment of the preforms (at least together with the shaping of the preforms into containers), wherein the throughput of the production machine with which the preforms are produced and the blow molding machine or other machine shaping the preforms into containers is substantially the same and an immediate transport and further processing of the preforms takes place after their production in the injection molding machine. In particular, during normal operation, the preforms are fed directly to the blow molding machine via suitable transport devices, which blow molding machine then processes them.

However, retooling work is necessary during the operation of blocked plants. In this case, one or more components of at least one of the machines are exchanged, for example in order to carry out a format change in which components that are suitable for containers and/or preforms of a first shape are exchanged for components that are suitable for containers and/or preforms of a second shape.

With regard to blocked devices or plants, the prior art does not disclose how a retooling can be carried out, especially with reduced personnel deployment.

### Object

Based on the known prior art, the technical object to be achieved is to provide a plant for producing containers and a method for retooling a plant with which different types of containers can be flexibly produced.

### Solution

This object is achieved in accordance with the disclosure by a plant for producing containers and a method for producing containers using a plant for producing containers as described herein.

The plant according to the disclosure for producing containers comprises a production machine for producing preforms, a blow molding machine for producing containers from the preforms and a transport device for transporting the preforms from the production machine to the blow molding machine, wherein the plant comprises a retooling apparatus for retooling at least one component of the production machine and/or the blow molding machine.

The production machine can, for example, be or comprise an injection molding machine. Other embodiments of the production machine, such as a compression machine or compression molding machine, are also conceivable and the disclosure is not limited with regard to the type of production machine.

While the blow molding machine is described below as basically comprising at least apparatuses for molding the containers (for example blow molding), it can also be provided that the blow molding machine comprises, upstream of these apparatuses, one or more heating devices for heating the preforms, for example an oven, in particular an infrared oven or a microwave oven or a laser oven for heating the preforms or any combinations thereof.

The retooling apparatus can in particular comprise one or more tools and/or robots with which a retooling of a component of the production machine and/or the blow molding machine is made possible. The retooling can be carried out either fully automatically by the retooling apparatus alone without interaction with an operator or in cooperation with an operator.

The component of the production machine and/or the blow molding machine can in principle be any structural component of these machines. With regard to the injection molding machine, in particular a retooling or replacement of an injection molding tool can be provided as a component; with regard to the blow molding machine, in particular blow molds can be retooled as components.

The plant according to the disclosure allows for a simple and at least partially, optionally fully automated, retooling process or adaptation of the machines to different container types and/or preform types.

It can be provided that the transport device comprises a buffer device for storing preforms, wherein the plant comprises a control unit that is configured to control the transport of the preforms in the transport device such that preforms are fed to the buffer device from a transport path of the transport device while the blow molding machine is being retooled and a transport of preforms to the blow molding machine is interrupted, and/or such that preforms are fed from the buffer device to the blow molding machine while the production machine is being retooled.

This buffer device can ensure that the retooling is carried out as efficiently as possible and with minimal downtime, especially if the retooling times of the blow molding machine and the production machine are different or if only one of these machines is to be retooled.

In one embodiment, it is provided that the buffer device comprises at least two buffer rows, which can be introduced into the transport path of the transport device for receiving and/or conveying preforms and can be moved out of the transport path for buffering preforms.

This embodiment allows the buffer device to be integrated into the transport path of the transport device, which can reduce the spatial requirement of the plant.

It can be provided that the transport device upstream of the buffer device comprises a blocking element for selectively blocking and releasing a transport of preforms into the buffer device.

This embodiment ensures a reliable feeding of preforms to the buffer device, so that even when buffering is necessary, there are reduced operational disruptions.

The transport path may comprise conveyor rails for the preforms and the buffer rows may comprise receiving rails for receiving the preforms. This makes it easier to integrate the buffer device into the transport device.

It can be provided that the retooling apparatus comprises a retooling unit assigned to the blow molding machine and/or a retooling unit assigned to the production machine and/or that the retooling apparatus comprises a retooling unit that can be moved between the blow molding machine and the production machine, wherein the retooling unit is configured to retool the at least one component.

The retooling units can be specifically adapted to the requirements of the blow molding machine and the production machine, so that, for example, tools for the retooling unit assigned to the production machine are different from the tools of the retooling unit assigned to the blow molding machine. If a movable retooling unit is provided, it can comprise tools that are adapted to the requirements of the blow molding machine and the production machine.

This embodiment allows either simultaneous retooling by using the retooling units assigned to the machines or a reduced complexity of the plant, while still ensuring reliable retooling.

It can be provided that the plant comprises a container handling machine downstream of the blow molding machine for treating containers produced in the blow molding machine and wherein the retooling apparatus is configured to retool at least one component of the container handling machine. Necessary changes to components of machines involved in the production and further processing of the containers can thus be carried out reliably.

The container handling machine may comprise a filler and/or a closer and/or a labeling machine and/or a printing machine and/or an inspection device. These machines usually require retooling when changing between types of containers to be produced, so that the disclosure can be particularly advantageously applied to these container handling machines.

According to the disclosure, a method for retooling a plant for producing containers is also provided, the plant comprising a production machine for producing preforms, a blow molding machine for producing containers from the preforms and a transport device for transporting the preforms from the production machine to the blow molding machine, wherein the plant comprises a retooling apparatus for retooling at least one component of the production machine and/or the blow molding machine, wherein the method comprises retooling at least one component of the production machine and/or the blow molding machine with the retooling apparatus, wherein optionally preforms are produced with the production machine at least partially during the retooling of the blow molding machine and/or optionally preforms are formed into containers with the blow molding machine at least partially during the retooling of the production machine.

This method allows a change of type or retooling to be carried out with reduced downtime of the plant.

It can be provided that the transport device comprises a buffer device for storing preforms, wherein the plant comprises a control unit that controls the transport of the preforms in the transport device such that preforms are fed to the buffer device from a transport path of the transport device while the blow molding machine is being retooled and a transport of preforms to the blow molding machine is interrupted, and/or such that preforms are fed from the buffer device to the blow molding machine while the production machine is being retooled.

The use of these buffer devices can allow continued operation of the blow molding machine and/or the production machine even during retooling of the other machine, thus minimizing plant downtime.

It can be provided that the transport device upstream of the buffer device comprises a blocking element for selectively blocking and releasing a transport of preforms into the buffer device, wherein the method comprises at least temporarily blocking the transport of the preforms into the buffer device.

For example, the transport of the preforms into the buffer device can be blocked if a buffer row of the buffer device is removed from the transport path of the transport device in order to buffer the preforms contained therein. This prevents preforms from being inadvertently transferred to a buffer device that is not ready to receive the preforms, thus avoiding unintentional interruptions in operation.

In one embodiment, it is provided that the method comprises retooling the blow molding machine and the production machine, wherein after the retooling of the production machine and before the end of the retooling of the blow molding machine, the production machine produces preforms and the preforms are fed to the buffer device, and wherein after the retooling of the blow molding machine, preforms from the buffer device are fed to the blow molding machine for producing containers, and wherein the production machine is operated at least temporarily at a reduced throughput after the retooling of the blow molding machine.

The reduced throughput is therefore to be understood in comparison to the throughput of the production machine during an operating state of the plant during which the blow molding machine is not being retooled. The reduced throughput can be determined based on the number of preforms contained in the buffer device and the throughput of the blow molding machine, so that after a predetermined or dynamically calculated period of time has elapsed, the buffer device is emptied and the throughput of the production machine can then be increased again to the non-reduced throughput, where the throughput of the production machine is optionally equal to the throughput of the blow molding machine or equal to the throughput of all blow molding machines in the plant if more than one blow molding machine is provided.

It may be provided that the production machine is operated at the reduced throughput until the buffer device is emptied. This avoids a reduction in the achievable throughput of containers produced by the plant.

The method may comprise retooling the blow molding machine and the production machine, and the retooling apparatus may retool the blow molding machine and the production machine at least partially simultaneously.

In this context, at least partially simultaneous retooling is to be understood as meaning that the retooling apparatus is involved in or carries out the retooling of a component of the blow molding machine and the production machine at least during an overlapping period, which does not have to be the same as the retooling time of the production machine and/or the blow molding machine. This allows downtimes to be minimized when changing types.

It can be provided that the plant downstream of the blow molding machine comprises a container handling machine for treating containers produced in the blow molding machine and that the retooling apparatus is configured to retool at least one component of the container handling machine, wherein the method comprises retooling the component of the container handling machine, wherein optionally the container handling machine comprises a filler and/or a closer and/or a labeling machine and/or a printing machine and/or an inspection device.

This makes it possible to reliably retool the entire plant, for example when changing the type or format of the containers.

### BRIEF DESCRIPTION OF THE FIGURES

FIG. 1 shows a schematic view of a plant according to an embodiment

FIGS. 2, 3, and 4 show different embodiments of a buffer device

### DETAILED DESCRIPTION

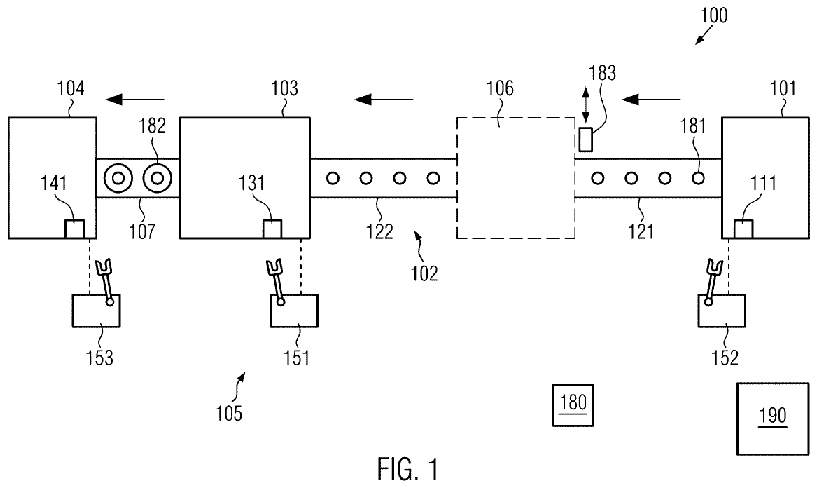

FIG. 1 shows a schematic view of a plant 100 according to the disclosure for producing containers 182 according to an embodiment.

According to the disclosure, the plant 100 comprises at least one production machine 101 for producing preforms. The production machine 101 can be configured, for example, as an injection molding machine or compression molding machine or compression machine, which produces preforms from a preform starting material, in particular PET (virgin PET but also rPET), from which containers can then be formed. However, the production machine is not limited in terms of its exact structure.

According to the disclosure, the plant 100 further comprises a transport device 102 that can remove preforms from the production machine 101 and feed them to the blow molding machine 103 provided according to the disclosure, in which the preforms 181 can be formed into containers 182 by biaxial stretching and in particular by applying blow pressure and stretching with a stretching rod.

The transport device 102 can be configured at least partially as an air conveyor, which can comprise two conveyor rails running parallel to one another, which can receive the preforms with their support rings in a hanging manner and can transport them using an air pressure flow from the production machine 101 in the direction of the blow molding machine 103. Alternatively or additionally, the transport device for taking over preforms from the production machine 101 and/or for transferring preforms to the production machine 103 can also comprise further transport elements, such as clamp grippers and/or rotary stars with suitable grippers that can take over and transport the preforms. Any sorting devices that cause the preforms to be rearranged after they have been produced in the production machine and before they are transferred to, for example, an air conveyor may also be provided, but are not described in further detail here.

The plant may further comprise a container handling machine 104 arranged downstream of the blow molding machine 103, which can further treat the containers produced in the blow molding machine 103. The container handling machine 104 can be configured in particular but not exclusively to comprise a filler and/or a closer and/or a labeling machine and/or a printing machine and/or an inspection device. In general, any machine that can interact with or act on the container to determine and/or influence a property of the container can be understood as a container handling machine.

A filler can introduce a product into the produced container 182 whereas a closer can seal the already filled container. A closer can advantageously but not exclusively be arranged directly downstream (without another container handling machine in between) of the blow molding machine if the blow molding machine is configured as a form-and-fill machine that uses the product to be filled into the container to form the container instead of using compressed air. A separate filler downstream of the blow molding machine is not necessary in this embodiment.

Labeling machines and printing machines can apply decorative elements to the containers 182 produced and are generally known from the prior art. For example, an optical inspection device such as a camera can be provided as an inspection device, which can check the containers 182 produced with regard to their quality.

Between the container handling machine 104 and the blow molding machine 103, a further transport device 107 (for example a linear conveyor, such as an air conveyor, or one or more rotary stars) can optionally be arranged, which can take over the containers 182 and feed them to the container handling machine 104.

According to the disclosure, the plant 100 further comprises a retooling apparatus 105 that is suitable for retooling at least one component of the production machine and/or the blow molding machine. The component 111 of the production machine 101 can, for example, be an injection molding tool if the production machine 101 is configured as an injection molding machine. The component 131 of the blow molding machine 103 can, for example, be a blow mold or a component of the blow mold with which a preform can be formed into a container. Alternatively or additionally, the component 131 may also be a horizontal bar.

In one embodiment, the retooling apparatus comprises a plurality of retooling units 151 and 152, of which at least one is assigned to the blow molding machine 103 and the production machine 101 and can retool the respective components. In an alternative embodiment, it can also be provided that a single retooling unit (for example the retooling unit 152) is provided so as to be movable between the production machine and the blow molding machine 103, and can be moved between the production machine 101 and the blow molding machine 103 for retooling the at least one component 111 and/or 131. The movable retooling unit can, for example, be arranged on rails or can be implemented as a robot that can move freely in space or at least in the plane.

Optionally, one or more component storage areas 190 can also be provided, which can store the components of the production machine and/or blow molding machine that are to be replaced. If a movable retooling unit is provided, it can be arranged so that it can move not only between the blow molding machine and the production machine, but also between the storage area 190, so that the retooling unit can remove the component to be replaced with the component installed in the respective machine from the storage area 190. If retooling units are permanently assigned to the machines, it can be provided that each retooling unit is assigned a component storage area from which the retooling units can remove components for retooling the respective machine.

The retooling units can be configured as stationary retooling units or movable retooling units, such as an AGV (Automated Guided Vehicle) with associated tools, so that they can at least participate in the retooling of the component or carry it out completely. Basically, each retooling unit comprises at least one tool and/or a robot arm with which the retooling unit can carry out the retooling of the machine either fully automatically or partially in interaction with an operator. For this purpose, the retooling unit can also comprise sensors to detect physical objects, such as operators and/or parts of the machine to be retooled, for example.

If the plant 100 comprises a container handling machine 104, a retooling unit 153 of this container handling machine 104 can also be provided for retooling at least one component 141 of the container handling machine. Alternatively, as already described above, the movable retooling unit can be configured such that it is arranged so as to be movable (for example on rails) between the container handling machine, the blow molding machine, the production machine and optionally the component storage area 190 and can thus carry out a retooling of each of the components 111, 131 and 141.

The component of the container handling machine can, for example, comprise a filling element and/or a print head and/or a labeling unit or a component of a labeling unit (such as a pallet shaft) and/or a closer head for applying a closure to the container, depending on how the container handling machine is configured and which component is being replaced.

In a further embodiment, it can be provided that the plant 101, in particular the transport device 102, comprises a buffer device 106 in which preforms 181 can be stored. The buffer device 106 can be arranged between two parts or portions 121 and 122 of the transport device, so that preforms 181 can be fed by the transport device or portion 121 of the transport device 102 first from the production machine 101 to the buffer device 106 and then removed from the buffer device 106 by the portion 122 of the transport device 102 and fed to the blow molding machine 106.

In an embodiment, it is provided that the buffer device 106 does not permanently buffer preforms, but is configured as part of the transport device 102 or functions when no buffering of the preforms is required. In this case, the buffer device functions as part of the transport device, so that there is as little difference as possible in the distance traveled by the preforms compared to a continuous transport device 102 without a buffer device.

It can be provided that upstream (and/or optionally downstream) of the buffer device 106 a blocking element 183 is arranged for selectively blocking and releasing a transport of preforms into the buffer device or out of the buffer device. The blocking element 183 can, for example, be arranged upstream in a region of an air conveyor provided for the transport of the preforms 181, so that, for example, a change in the buffer device, such as a displacement of a buffer row of the buffer device, can be carried out, while the preforms 181 are prevented from moving in the direction of the buffer device 106 by blocking the transport with the blocking element.

In each of the described embodiments, the plant may comprise a control unit 180 (for example a computer with associated processor and memory) that can control the functions of the plant 100 and in particular the retooling of the production machine and/or the blow molding machine and, if provided, the container handling machine 104. For this purpose, the control unit can, for example, transmit control commands to the retooling apparatus to instruct it to carry out the retooling. In addition, the control unit can be configured such that it can control the locking element 183 for locking or releasing the transport device and/or the feeding or removal of preforms into or out of the buffer device 106, for example depending on a retooling of the blow molding machine 103 and/or the production machine 101.

It can be provided that the control unit is configured to control the plant in such a way that during a retooling of the blow molding machine 103, the preforms 181 produced with the production machine 101 are buffered in the buffer device and are not transported further to the blow molding machine 103. If the production machine is retooled, it can be provided that at least partially during the retooling of the production machine 101, preforms are fed from the buffer device 106 to the blow molding machine in order to form them into containers 182 during the retooling of the production machine. This can reduce the downtime of the production machine and/or the blow molding machine 103 when retooling the other machine. Alternatively or additionally, it can also be provided here that (in particular when providing retooling units 151 and 152 respectively assigned to the production machine 101 and the blow molding machine 103) the retooling of the blow molding machine and the production machine takes place at least partially simultaneously.

For example, it can be provided that during a planned retooling of the production machine and the blow molding machine, the production machine is initially stopped and the blow molding machine continues to operate until the preforms 181 that were last produced with the production machine have been formed into containers 182.

In the meantime, the retooling unit 152 can already be used to retool the production machine. If there are no more containers to be molded in the blow molding machine 103, the operation of the blow molding machine 103 can be stopped and the retooling process can be started (for example using the retooling unit 151). As soon as the retooling of the production machine 101 is completed, it can be put into operation again and produce preforms 181 (optionally at a reduced throughput compared to normal operation), wherein these preforms 181 are then fed to the buffer device 106 for buffering and not to the blow molding machine 103. As soon as the blow molding machine 103 has been retooled, it can be put into operation again and at least preforms from the buffer device 106 can be transferred to the blow molding machine 103 for forming into containers 182. In this case, further operation of the production machine 101 can take place at reduced throughput, so that the buffer device 106 is initially emptied and yet enough preforms are produced to feed the blow molding machine 103. The throughput of the production machine can, for example, be reduced by up to 10% or up to 20% or up to 50% compared to normal operation, so that the number of preforms fed to the buffer device during this operating phase is lower than the number of preforms removed from the buffer device per unit of time. This causes the buffer unit to be gradually emptied.

If the buffer device 106 has been emptied (i.e. no longer contains any buffered or stored preforms), the throughput of the production machine 101 can be increased again and, for example, adjusted to the throughput of the blow molding machine (or the combined throughput of all blow molding machines in the plant if more than one blow molding machine is provided), so that the normal operation of the plant can be continued until a retooling is required again.

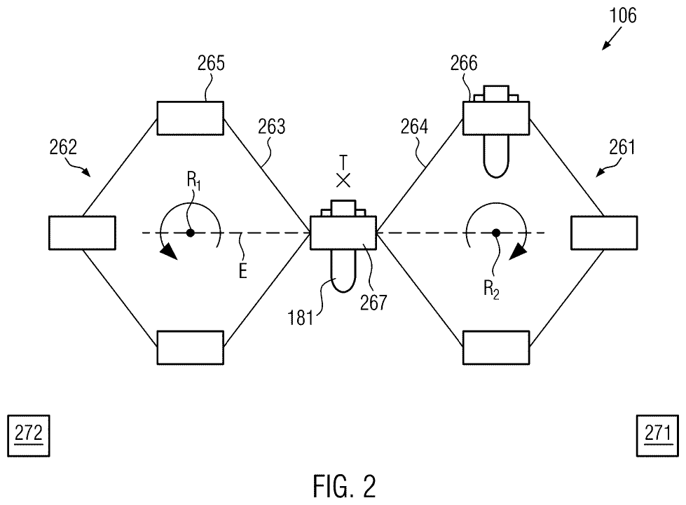

FIGS. 2 to 4 show various embodiments of the buffer device 106, which can be particularly advantageously combined with an at least partially simultaneous retooling of the blow molding machine and the production machine, since they have at most only a slight, optionally no influence on the transport of the preforms during normal operation and allow flexible continued operation of the blow molding machine and/or the production machine during the retooling.

FIG. 2 shows an embodiment of the buffer device 106 in which the buffer device 106 comprises two buffer elements 261 and 262 optionally arranged one behind the other in the transport direction T. The buffer elements 261 and 262 comprise an optionally rigid frame 263 and 264, respectively, which can in particular be made of stainless steel. On this frame, in each buffer unit 261 and 262, a plurality of (at least two) buffer rows 265 and 266 are arranged, into which preforms can be inserted by the transport device and which extend in the transport direction T. The buffer capacity of each buffer row depends on the extension of the preforms in the transport direction T and the length of the particular buffer row. This embodiment is particularly advantageous if the transport device comprises a transport track that comprises two conveyor rails arranged parallel to one another, between which the preforms are transported hanging with their support ring (for example using an airflow). In this case, the buffer rows 265 and 266 of the buffer units 261 and 262 can also comprise receiving rails between which the preforms can be received in a hanging manner with their support rings. In this embodiment, each buffer row can further be assigned one or more air nozzles that can apply an airflow in the transport direction T on the preforms in order to remove them from the buffer device.

The transition from the transport path to the buffer row can be realized for the preforms with reduced force in a direction different from the transport device T, which can avoid desired misalignments of the preforms. For this purpose, it can be provided that a vertical offset between the receiving rails and the conveyor rails when the preforms are taken over from the transport device into a buffer row is as small as possible, optionally less than 3 mm, and optionally less than 2 mm.

The buffer rows are further optionally mounted on the frames 263 and 264 such that the preforms are always hung vertically along their longitudinal axis.

In the embodiment shown, a buffer row 267 (for example a buffer row of the buffer unit 261 or buffer rows 267 of the buffer units 261 and 262 arranged one after the other in the transport direction) is first loaded with preforms. Subsequently, the locking element (see FIG. 1) is optionally actuated to block the further transport of preforms into the buffer device. The loaded buffer unit 261 is then rotated about the respective rotation axis (R₁ or R₂) with the aid of a drive element 271 (for example a servomotor) assigned to the buffer unit, so that the loaded buffer row (in which preforms are buffered) is removed from the transport path of the transport device in the direction of rotation shown and the next buffer row of either the same buffer unit and/or the other buffer unit is introduced into the transport path so that it can be loaded with preforms. A corresponding drive element 272 is also assigned to the other buffer unit 262.

The rotation axes R₁ and R₂ are optionally arranged here such that they run in a transport plane E of the preforms and parallel to the transport direction T, so that in the vertical direction there is no difference in height between the transport path of the transport device and the buffer row 267 receiving the preforms 181.

As already mentioned, it can be provided that the buffer units 261 and 262 are arranged one behind the other (in the transport direction T), so that preforms can be fed in one buffering process in both buffer units or in the buffer rows 267 arranged one behind the other in the transport direction T. Alternatively, it can also be provided that the buffer units 261 and 262 are arranged at the same height in the transport direction T, so that preforms are alternately fed to the buffer rows of the buffer units 261 and 262.

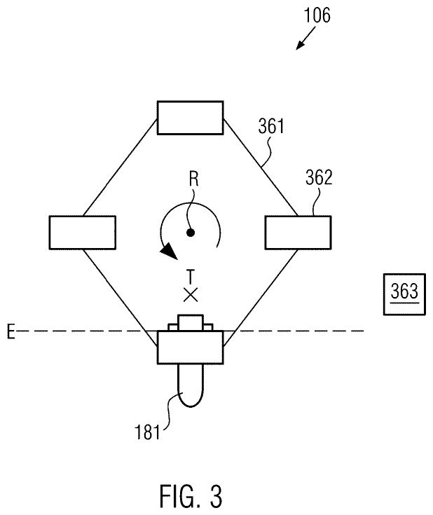

FIG. 3 shows an alternative embodiment to FIG. 2. In this embodiment, the buffer device comprises a frame 361 with buffer rows 362 arranged thereon, analogously to the embodiment of FIG. 2. In this embodiment, however, the frame is arranged to be rotatable about a rotation axis R that is vertically offset from the transport plane E but runs parallel to the transport direction T. The vertical offset can be either up (against the direction of gravity) or down (in the direction of gravity). Furthermore, the buffer device 106 comprises a drive element 363 (for example a servomotor) that is configured to drive the frame and the buffer rows 362 arranged thereon so that they can be rotated about the rotation axis R and introduced into a transport path of the transport device in order to receive preforms 181.

The basic structure of this buffer device corresponds to the structure of a buffer unit of the embodiment of FIG. 2 except for the relative arrangement in relation to the transport path of the transport device with respect to the rotation axis R of the buffer device. However, all other embodiments described with reference to FIG. 2 are also applicable in conjunction with FIG. 3.

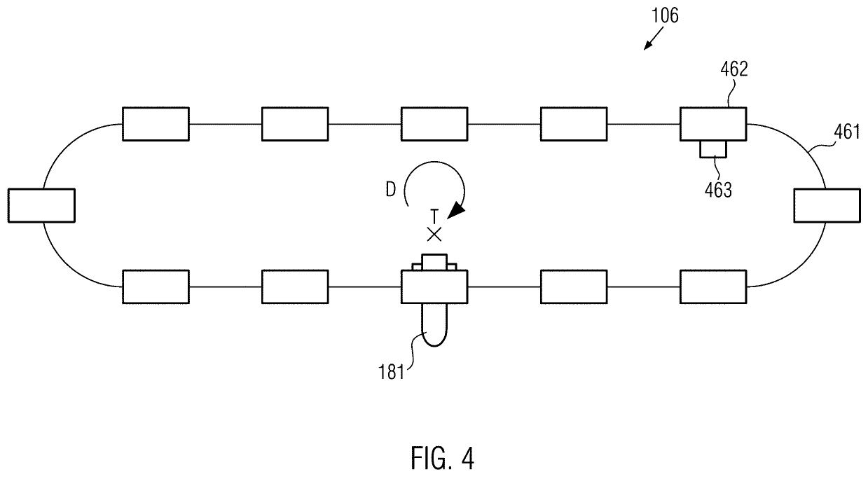

FIG. 4 shows an alternative embodiment to the embodiments of FIGS. 2 and 3. In this embodiment of the buffer device 106, a plurality of buffer rows 362 are again provided, which are movably arranged in a plane of movement perpendicular to the transport direction T along a guide 461 in order to be introduced into the transport path of the transport device and to take over preforms there. Instead of the rigid, rotatably arranged frame according to the embodiments of FIGS. 3 and 4, however, in this embodiment it is provided that the buffer rows are arranged on independently movable carriages 463 that can be moved along the guide 461 along the illustrated direction of movement D. The guide 461 can in particular be configured as part of a linear drive (as a stator) and the carriages 463 connected to the buffer rows 462 can be configured as movers that can be selectively moved by electromagnetic interaction with the guide 461. As a result, the number of preforms that can be taken into or removed from the buffer device 106 per unit of time can be selectively controlled and, for example, controlled depending on the throughput of the blow molding machine and/or the throughput of the production machine when retooling one of these machines.

With the described embodiments of the buffer device, together with the retooling apparatus, an efficient, at least partially automated retooling of the machines of the plant can be carried out, wherein downtimes in particular are reduced.

1. A plant for producing containers, the plant comprising a production machine for producing preforms, a blow molding machine for producing containers from the preforms and a transport device for transporting the preforms from the production machine to the blow molding machine, wherein the plant comprises a retooling apparatus for retooling at least one component of the production machine and/or the blow molding machine.

2. The plant according to claim 1, wherein the transport device comprises a buffer device for storing preforms, wherein the plant comprises a control unit that is configured to control the transport of the preforms in the transport device such that preforms are fed to the buffer device from a transport path of the transport device while the blow molding machine is being retooled and a transport of preforms to the blow molding machine is interrupted, and/or such that preforms are fed from the buffer device to the blow molding machine while the production machine is being retooled.

3. The plant according to claim 2, wherein the buffer device comprises at least two buffer rows, which can be introduced into the transport path of the transport device for receiving and/or conveying preforms and can be moved out of the transport path for buffering preforms.

4. The plant according to claim 2, wherein the transport device upstream of the buffer device comprises a blocking element for selectively blocking and releasing a transport of preforms into the buffer device.

5. The plant according to claim 3, wherein the transport path comprises conveyor rails for the preforms, and wherein the buffer rows comprise receiving rails for receiving the preforms.

6. The plant according to claim 1, wherein the retooling apparatus comprises a retooling unit assigned to the blow molding machine and/or a retooling unit assigned to the production machine, and/or wherein the retooling apparatus comprises a retooling unit that can be moved between the blow molding machine and the production machine, wherein the retooling unit is configured to retool the at least one component.

7. The plant according to claim 1, wherein the plant comprises a container handling machine downstream of the blow molding machine for treating containers produced in the blow molding machine, and wherein the retooling apparatus is configured to retool at least one component of the container handling machine.

8. The plant according to claim 7, wherein the container handling machine comprises a filler and/or a closer and/or a labeling machine and/or a printing machine and/or an inspection device.

9. A method for retooling a plant for producing containers, the plant comprising a production machine for producing preforms, a blow molding machine for producing containers from the preforms and a transport device for transporting the preforms from the production machine to the blow molding machine, wherein the plant comprises a retooling apparatus for retooling at least one component of the production machine and/or the blow molding machine, wherein the method comprises retooling at least one component of the production machine and/or the blow molding machine with the retooling apparatus, wherein optionally preforms are produced with the production machine at least partially during the retooling of the blow molding machine and/or optionally preforms are formed into containers with the blow molding machine at least partially during the retooling of the production machine.

10. The method according to claim 9, wherein the transport device comprises a buffer device for storing preforms, wherein the plant comprises a control unit that controls the transport of the preforms in the transport device such that preforms are fed to the buffer device from a transport path of the transport device while the blow molding machine is being retooled and a transport of preforms to the blow molding machine is interrupted, and/or such that preforms are fed from the buffer device to the blow molding machine while the production machine is being retooled.

11. The method according to claim 10, wherein the transport device upstream of the buffer device comprises a blocking element for selectively blocking and releasing a transport of preforms into the buffer device, wherein the method comprises at least temporarily blocking the transport of the preforms into the buffer device.

12. The method according to claim 10, wherein the method comprises retooling the blow molding machine and the production machine, wherein after the retooling of the production machine and before the end of the retooling of the blow molding machine, the production machine produces preforms and the preforms are fed to the buffer device, and wherein after the retooling of the blow molding machine, preforms from the buffer device are fed to the blow molding machine for producing containers, and wherein the production machine is operated at least temporarily at a reduced throughput after the retooling of the blow molding machine.

13. The method according to claim 12, wherein the production machine is operated at the reduced throughput until the buffer device is emptied.

14. The method according to claim 9, wherein the method comprises retooling the blow molding machine and the production machine, and wherein the retooling apparatus retools the blow molding machine and the production machine at least partially simultaneously.

15. The method according to claim 9, wherein the plant downstream of the blow molding machine comprises a container handling machine for treating containers produced in the blow molding machine, and wherein the retooling apparatus is configured to retool at least one component of the container handling machine, wherein the method comprises retooling the component of the container handling machine, wherein optionally the container handling machine comprises a filler and/or a closer and/or a labeling machine and/or a printing machine and/or an inspection device.
